(19) United States
(12) Patent Application Publication
(10) Pub. No.: US 2011/0078800 A1
(43) Pub. Date: Mar. 31, 2011

(54) DIGITAL CONTENT MANAGEMENT METHODS AND SYSTEMS

(76) Inventors: Kai-Liang KO, Kaohsiung City (TW); Yung-Sen JANG, Kaohsiung (TW); Jay SZETU, Taipei City (TW); Wen-Tai HSIEH, Taipei City (TW)

(21) Appl. No.: 12/751,137

(22) Filed: Mar. 31, 2010

(30) Foreign Application Priority Data
Sep. 29, 2009 (TW) 98132893

(51) Int. Cl. G06F 21/24

(52) U.S. Cl. 726/26

(57) ABSTRACT

Digital content management methods and systems are provided. First, device ID of a first electronic device is received, and a data license including at least the device ID of the first electronic device, and a control license including at least a read authorization for a digital content are generated. Then, the digital content and the control license are packed as a content package, and the content package and the data license are respectively transmitted to the first electronic device. An electronic device determines whether the device ID of the electronic device conforms to the device ID recorded in the data license. If so, the digital content in the content package is allowed to be read according to the control license. A new data license is generated for the digital content according to the device ID of a second electronic device. The new data license is stored to the second electronic device, and the data license in the first electronic device is abrogated. Then, the content package is transmitted from the first electronic device to the second electronic device.

### CROSS REFERENCE TO RELATED APPLICATIONS

This Application claims priority of Taiwan Patent Application No. 098132893, filed on Sep. 29, 2009, the entirety of which is incorporated by reference herein.

### BACKGROUND OF THE INVENTION

1. Field of the Invention

The disclosure relates generally to digital content management methods and systems, and more particularly, to methods and systems that generate a data license and a control license for digital content, wherein the data license and the control license are independent, and manage the digital content in an electronic device according to the data license and the control license, and/or transmit the digital content among electronic devices.

2. Description of the Related Art

With electronic devices, such as computers or portable devices, being popular, digital data has become a major data recording type for these devices. Currently, digital content can be delivered in an on-line manner. For example, the digital content and license treated by DRM (Digital Right Management) can be downloaded via a communication network to a playback device. When the digital content and the license are delivered to the playback device, the digital content will be bundled with a device ID (Identification) of the playback device, such that the digital content can be only played back in the playback device. Additionally, in some practices, the digital content can be bundled with the device ID of the playback device in advance before it is delivered to the playback device, and transmitted to the playback device. When an electronic device wants to read digital content, it must first determined whether the device ID of the electronic device matches the device ID bundled with the digital content. If the device ID of the electronic device matches the device ID bundled with the digital content, the electronic device is allowed to read the digital content. In this manner, the digital content is forced to be bundled to a specific device, thus seriously limiting a user's use right of the digital content when the user wants to access the digital content in other devices.

For example, Taiwan Patent No. 1249318 discloses a method that allows digital content to be played back in several devices. When a user wants to play back digital content in several devices, the user must provide related information of the devices to the content providers of the digital content in advance. The content provider can generate a license based on the related information of the devices. In this manner, as described, since the user must provide related information of related devices to the content provider in advance, it is complicated and time-consuming. Additionally, when the user wants to add or replace another device, the user must provide related information of another device again, and a license must be accordingly re-generated again, thus resulting in inconvenience to the user. Further, related conventional arts cannot record the use and transfer situations of digital content, resulting in difficulties of digital content management.

### BRIEF SUMMARY OF THE INVENTION

Digital content management methods and systems are provided.

In an embodiment of a digital content management method, a device ID of a first electronic device is received, and a data license and a control license are generated for a digital content. The data license records at least the device ID of the first electronic device, and the control license records at least a read authorization of the digital content. Then, the digital content and the control license are packed as a content package including at least the digital content and the control license, and the content package and the data license are respectively transmitted to the first electronic device.

In an embodiment of a digital content management method, a first electronic device obtains a content package and a data license. The data license records at least a device ID. The content package at least includes a digital content and a control license recording at least a read authorization of the digital content. It is determined whether the device ID of the first electronic device conforms to the device ID recorded in the data license. If the device ID of the first electronic device conforms to the device ID recorded in the data license, the digital content in the content package is allowed to be read according to the read authorization in the control license.

In an embodiment of a digital content management method for use in a first electronic device and a second electronic device, wherein the first electronic device includes a data license at least recording the device ID of the first electronic device, and a content package at least includes a digital content and a control license recording at least a read authorization of the digital content, the device ID of the second electronic device is first obtained, and a new data license is generated for the digital content according to the device ID of the second electronic device. The new data license at least records the device ID of the second electronic device. Then, the new data license is stored to the second electronic device, and the data license in the first electronic device is abrogated. Thereafter, the content package is transmitted from the first electronic device to the second electronic device.

An embodiment of a digital content management system includes a storage unit and a processing unit. The storage unit stores at least a digital content. The processing unit receives a device ID of a first electronic device, and generates a data license and a control license for the digital content. The data license records at least the device ID of the first electronic device, and the control license records at least a read authorization of the digital content. The processing unit packs the digital content and the control license as a content package, and respectively transmits the content package and the data license to the first electronic device.

An embodiment of a digital content management system includes a first electronic device having a storage unit and a processing unit. The storage unit records at least a content package and a data license. The data license records at least a device ID. The content package at least includes a digital content and a control license, recording at least a read authorization of the digital content. The processing unit obtains the data license, and determines whether the device ID of the first electronic device conforms to the device ID recorded in the data license. If the device ID of the first electronic device conforms to the device ID recorded in the data license, the processing unit allows the digital content in the content package to be read according to the read authorization in the control license.

An embodiment of a digital content management system includes a first electronic device and a second electronic device. The first electronic device includes a storage unit recording at least a content package and a data license. The data license records at least a device ID of the first electronic device. The content package at least includes a digital content and a control license recording at least a read authorization of the digital content. A processing unit of the first electronic device or the second electronic device obtains the device ID of the second electronic device, and generates a new data license for the digital content according to the device ID of the second electronic device. The new data license at least records the device ID of the second electronic device. The processing unit of the first electronic device or the second electronic device stores the new data license to the second electronic device, and abrogates the data license in the first electronic device. The processing unit of the first electronic device or the second electronic device transmits the content package from the first electronic device to the second electronic device.

In some embodiments, identity data corresponding to a client can be received, and the client is verified according to the identity data. When the verification of the client is passed, the data license and the control license are generated. The identity data is further recorded in the data license. In some embodiments, the first electronic device can further receive identity data of a client, and determine whether the identity data of the client conforms to the identity data recorded in the data license. If the identity data of the client conforms to the identity data recorded in the data license, the digital content is allowed to be read in the first electronic device.

In some embodiments, a journal license can be further generated during the generation of the data license and the control license, and packed into the content package. The journal license is used to record a read record of the digital content. In some embodiments, when the digital content is read in the first electronic device, the journal license is updated by the first electronic device.

Digital content management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a digital content management system of the invention;

FIG. 2 is a schematic diagram illustrating an embodiment of the structure of a server of the invention;

FIG. 3 is a flowchart of an embodiment of a digital content management method for a server of the invention;

FIG. 4 is a schematic diagram illustrating an embodiment of the structure of an electronic device of the invention;

FIG. 4A is a schematic diagram illustrating an embodiment of the appearance of a PDA (Personal Digital Assistant) of the invention;

FIG. 4B is a schematic diagram illustrating an embodiment of the structure of a PDA of the invention;

FIG. 5 is a flowchart of an embodiment of a digital content management method for an electronic device of the invention;

FIG. 6 is a flowchart of another embodiment of a digital content management method for an electronic device of the invention; and

FIG. 7 is a flowchart of another embodiment of a digital content management method for two electronic devices of the invention.

### DETAILED DESCRIPTION OF THE INVENTION

Digital content management methods and systems are provided.

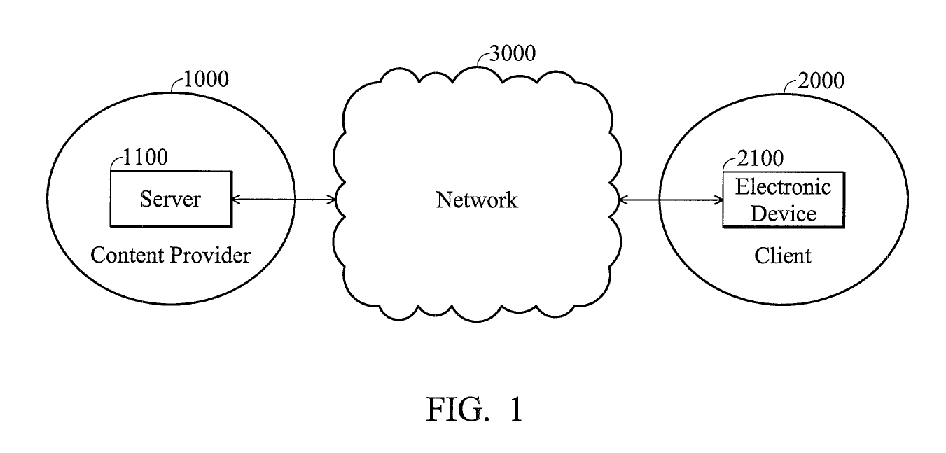

FIG. 1 is a schematic diagram illustrating an embodiment of a digital content management system of the invention. The digital content management system can be used in server 1100 and/or an electronic device 2100. The server 1100 can be located at a content provider 1000, providing digital contents and corresponding licenses. The electronic device 2100 may be located at a client 2000, which connects to the server 1100 of the content provider 1000 via a network 3000, to receive digital contents and corresponding licenses. It is understood that, the implementation of the licenses may be software, a hardware, or combination of software and hardware. For example, a data license may be an encrypted data file, or a key recorded or stored in a chip, such as a SIM (Subscriber Identity Module) card, a memory card, or a portable hardware, such as a portable disk.

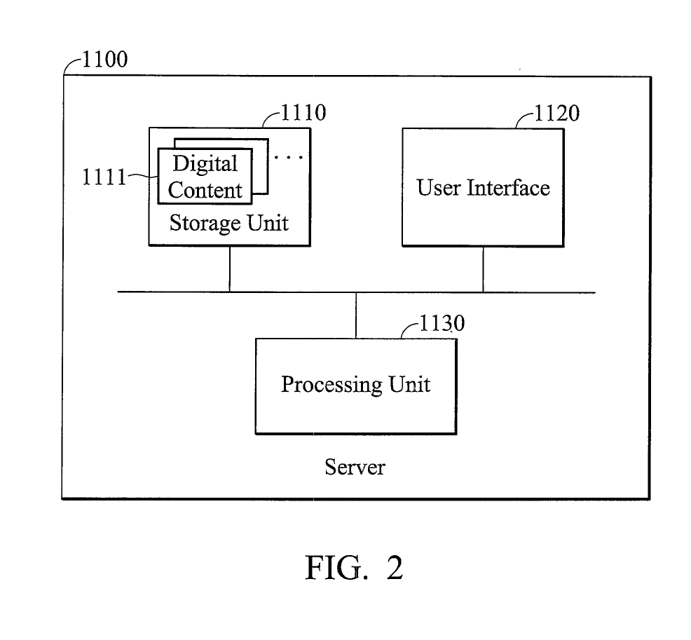

FIG. 2 is a schematic diagram illustrating an embodiment of the structure of a server of the invention. It is understood that, the server can be replaced by the other electronic device, such as a computer system, a notebook, a workstation, a portable device, or other processor-based devices.

The server 1100 comprises a storage unit 1110, at least one user interface 1120, and a processing unit 1130. The storage unit 1110 comprises at least a digital content 1111. In some embodiments, the digital content 1111 may be a DRM treated file. The user interface 1120 can receive related inputs from the client 2000. The processing unit 1130 can perform the digital content management method of the invention, which will be discussed further in the following paragraphs.

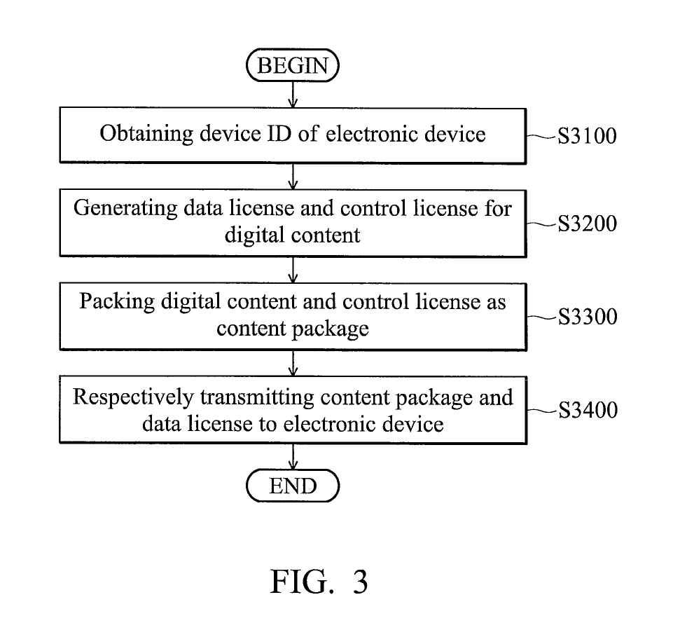

FIG. 3 is a flowchart of an embodiment of a digital content management method for a server of the invention.

In step S3100, a device ID of the electronic device 2100 is obtained via the user interface 1120. It is noted that, in some embodiments, the client 2000 can input the device ID of the electronic device 2100 to the server 1100 via the user interface 1120. In some embodiments, the server 1100 can automatically obtain the device ID of the electronic device 2100 via the user interface 1120. In step S3200, a data license and a control license are generated for the digital content 1111. The data license at least records the device ID of the electronic device 2100. The control license at least records a read authorization of the digital content 1111. The read authorization may be the number of times that the digital content 1111 can be read. Further, the control license can also record access authority of the digital content 1111. The access authority may be the number of times that the digital content 1111 can be accessed, transferred, and/or copied. It is noted that, the data license and the control license can be respectively stored, and/or protected using different manners. For example, the data license and the control license can be encrypted using different encryption manners, respectively transmitted, and/or hide by naming the specific file extensions different from that of general licenses. It is noted that, in some embodiments, the server 1100 can receive an authorization request corresponding to the digital content 1111 from the client 2000 via the user interface 1120, and the server 1100 can generate the control license according to the authorization request. In some embodiments, a journal license corresponding to the digital content 1111 can be further generated in step S3200. The journal license can be used to record a read record of the digital content 1111. Further, the journal license can record an access record of the digital content 1111. The access record may be the number of times that the digital content 1111 has been accessed/read, transmitted, and/or copied.

It is understood that, in some embodiment, the server 1100 can further receive identity data, such as user account and password from the client 2000 via the user interface 1120, to verify the client 2000. It is noted that, in some embodiments, data received from the client 2000 can stored in the storage unit 1110. When the verification of the client is passed, the server 1100 can generate the data license and the control license. At the time, the server 1100 can record the identity data of the client 2000 and the device ID of the electronic device 2100 in the data license. In step S3300, the digital content 1111 and the control license are packed as a content package, and in step S3400, the content package and the data license are respectively transmitted to the electronic device 2100. It is understood that, when a journal license of the digital content 1111 is generated in step S3200, the journal license will be simultaneously packed with the digital content 1111 and the control license as the content package to be transmitted to the electronic device 2100.

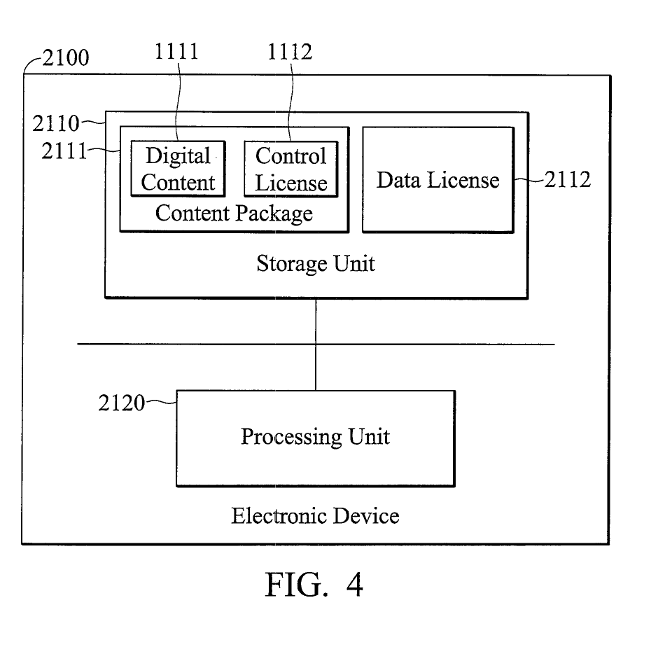

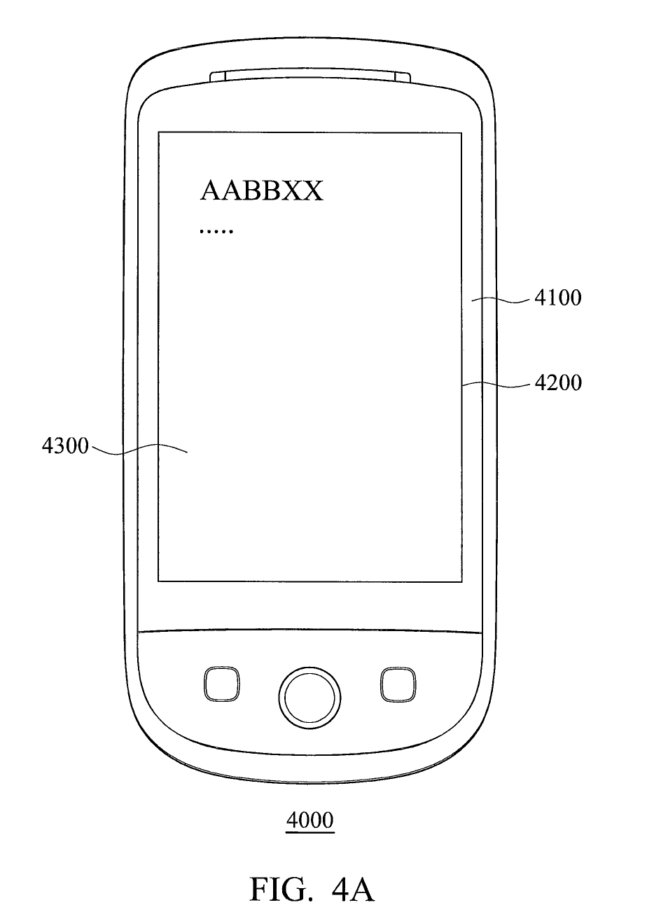

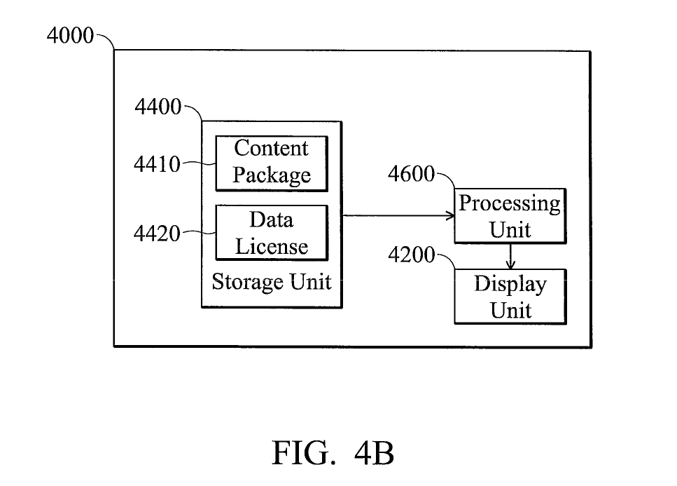

FIG. 4 is a schematic diagram illustrating an embodiment of the structure of an electronic device of the invention. It is understood that, the electronic device may be a personal computer, a notebook, a netbook, a PDA, a mobile phone, a handheld device, a MP3 player, an e-book reader, and other electronic devices.

The electronic device 2100 comprises a storage unit 2110 and a processing unit 2120. The storage unit 2110 comprises a content package 2111 and a data license 2112. The content package 2111 comprises a digital content 1111 and a control license 1112. Similarly, the control license 1112 at least records a read authorization of the digital content 1111. Further, the control license can also record an access authority of the digital content 1111. The data license 2112 records the device ID of the electronic device 2100. The processing unit 2120 can perform the digital content management method of the invention, which will be discussed further in the following paragraphs.

In some embodiments, the electronic device may be a portable device, such as a PDA, and the appearance of the PDA is shown in FIG. 4A. As shown in FIG. 4A, the PDA 4000 has a shell 4100 and a display unit 4200. The display unit 4200 is set outside the shell 4100 to display a digital content 4300. FIG. 4B is a schematic diagram illustrating an embodiment of the structure of a PDA of the invention. As shown in FIG. 4B, the PDA 4000 comprises a display unit 4200, a storage unit 4400, and a processing unit 4600. The storage unit 4400 is set inside of the shell 4100, and coupled to the processing unit 4600. The storage unit 4400 comprises a content package 4410 and a data license 4420. In another embodiment, the data license 4420 is not stored in the storage unit 4400. A portable hardware, such as a SIM card, a memory card, an IC (Integrated Circuit) card or a portable disk, can be used to store the identification data of the PDA 4000 as the data license. Similarly, the content package 4410 can comprise a digital content and a control license. The processing unit 4600 is set inside the shell 4100, to perform the digital content management method of the invention. The processing unit 4600 can further execute a browser or a reader to read the digital content, which will be discussed further in the following paragraphs. The display unit 4200 can be used to display related digital contents and data.

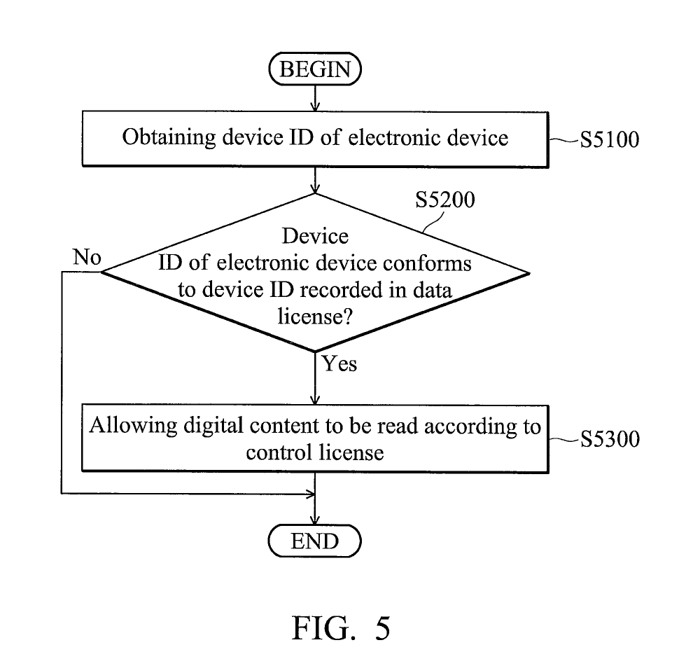

FIG. 5 is a flowchart of an embodiment of a digital content management method for an electronic device of the invention. In this embodiment, the content package 2110 stored in the storage unit 2110 of the electronic device comprises the digital content 1111 and the control license 1112.

In step S5100, the processing unit 2120 obtains the device ID of the electronic device 2100. In step S5200, it is determined whether the device ID of the electronic device 2100 conforms to the device ID recorded in the data license 2112. If the device ID of the electronic device 2100 does not conform to the device ID recorded in the data license 2112 (No in step S5200), the procedure is completed. If the device ID of the electronic device 2100 conforms to the device ID recorded in the data license 2112 (Yes in step S5200), in step S5300, the processing unit 2120 allows the digital content 1111 in the content package 2111 to be read according to the control license 1112. It is noted that, when the control license records an access authority, such as the number of times that the digital content 1111 can be accessed/read, transferred, and/or copied, the processing unit 2120 further allows the digital content 1111 to be accessed, transferred, and/or copied according to the control license 1112.

It is understood that, in some embodiments, when the device ID of the electronic device 2100 conforms to the device ID recorded in the data license 2112, the digital content 1111 and the control license 1112 can also be read and modified. It is noted that, the processing unit 2120 can further execute a browser or a reader to browse the digital content 1111. It is understood that, in some embodiments, the data license 2112 can record identity data, and the electronic device 2100 can further receive identity data of a client, and determines whether the identity data of the client conforms to the identity data recorded in the data license 2112. If the identity data of the client conforms to the identity data recorded in the data license 2112, the digital content 1111 is allowed to be read according to the control license 1112.

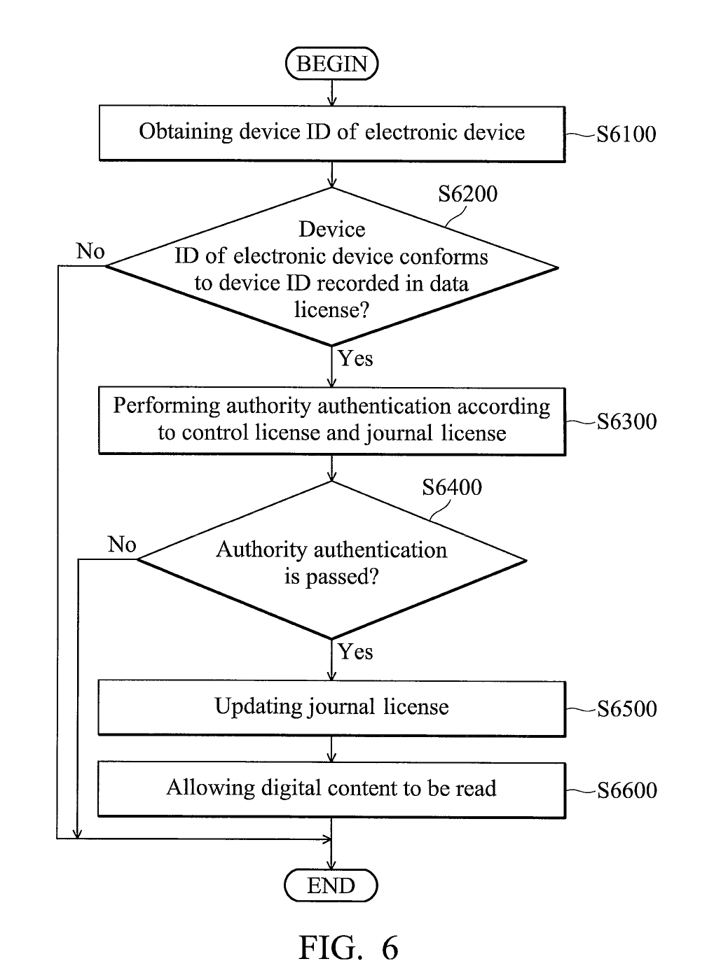

FIG. 6 is a flowchart of another embodiment of a digital content management method for an electronic device of the invention. In this embodiment, the content package 2111 stored in the storage unit 2110 of the electronic device 2100 comprises the digital content 1111, the control license 1112, and a journal license. The journal license can be used to record a read record of the digital content 1111.

In step S6100, the processing unit 2120 obtains the device ID of the electronic device 2100. In step S6200, it is determined whether the device ID of the electronic device 2100 conforms to the device ID recorded in the data license 2112. If the device ID of the electronic device 2100 does not conform to the device ID recorded in the data license 2112 (No in step S6200), the procedure is completed. If the device ID of the electronic device 2100 conforms to the device ID recorded in the data license 2112 (Yes in step S6200), in step S6300, the processing unit 2120 performs an authority authentication according to the control license 1112 and the journal license in the content package 2110. It is understood that, in some embodiments, in step S6300, it is determined whether the number of times the digital content 1111 has been read is less than the number of times that the digital content 1111 can be read recorded in the control license 1112. When the number of times that the digital content 1111 has been read is less than the number of times that the digital content 1111 can be read recorded in the control license 1112, the authority authentication is passed. If the authority authentication fails (No in step S6400), the procedure is completed. If the authority authentication passes (Yes in step S6400), in step S6500, the processing unit 2120 updates the journal license. For example, the number of times that the digital content 1111 has been read recorded in the journal license is added by one. Then, in step S6600, the processing unit 2120 allows the digital content 1111, in the content package 2111 to be read. Similarly, the processing unit 2120 can further execute a browser or a reader to browse the digital content 1111. Similarly, in some embodiments, the data license 2112 can record identity data, and the electronic device 2100 can further receive identity data of a client, and determines whether the identity data of the client conforms to the identity data recorded in the data license 2112. If the identity data of the client conforms to the identity data recorded in the data license 2112, the digital content 1111 is allowed to be read according to the control license 1112.

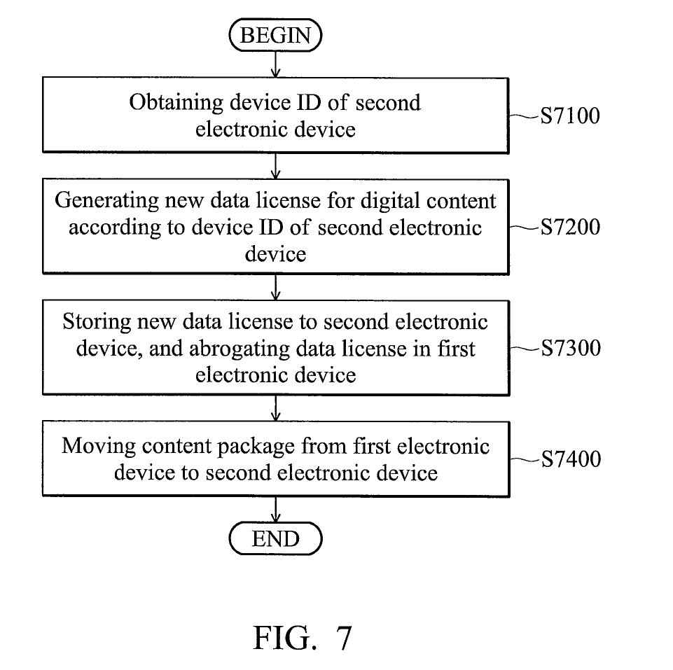

FIG. 7 is a flowchart of another embodiment of a digital content management method for two electronic devices of the invention. In this embodiment, a first electronic device and a second electronic device can be coupled with each other via a wired or wireless communication manner, and a digital content can be transferred between the first and second electronic devices. The first electronic device comprises a data license and a content package. The data license records at least a device ID of the first electronic device. The content package at least includes a digital content and a control license, wherein the control license records at least a read authorization of the digital content. In some embodiments, the content package can further comprise a journal license. It is noted that, in some embodiments, a processing unit of the first electronic device or the second electronic device can perform the digital content management method, such that the digital content can be transferred between the devices.

In step S7100, the processing unit of the first electronic device or the second electronic device executes a content transfer procedure to obtain the device ID of the second electronic device, and in step S7200, generate a new data license for the digital content 1111 according to the data license in the first electronic device and the device ID of the second electronic device. The new data license at least records the device ID of the second electronic device. It is noted that, when the data license in the first electronic device comprises identity data, the new data license may also comprise the identity data. It is understood that, in some embodiments, after the new data license is generated, a transfer record of the digital content can be generated, and recorded in the new data license. The transfer record can be used for subsequent management. It is also understood that, in some embodiments, when the digital content is transferred between the electronic devices of the same user, the identity data in the old data license and the new data license is the same. In some embodiments, when the digital content is transferred between the electronic devices of different users, the identity data in the old data license and the new data license is different. For example, after the first user sells the digital content to a second user, the identity data of the second user will be recorded in the new data license.

In step S7300, the new data license is transmitted and/or stored in the second electronic device, and the data license in the first electronic device is abrogated. It is noted that, the abrogation of the data license can be performed by directly deleting the data license, marking invalid data in the data license, or removing a unique ID from the data license, and moving the unique ID to the new data license, wherein only the new data license having the unique ID is valid. It is noted that, in some embodiments, after the unique ID is moved to the new data license, the old data license must be deleted. Further, in some embodiments, step S7300 can be accomplished using a transaction mechanism. The transaction mechanism is a series of data processing procedures, which can ensure the old data license is abrogated after the new data license is generated. In the transaction mechanism, an original state can be resumed if a failure occurs during the procedures, and the original state cannot be resumed when the old data license is abrogated.

Then, in step S7400, the content package is transmitted from the first electronic device to the second electronic device.

It is understood that, as described, the implement of the licenses may be software, hardware, or combination of software and hardware. When the license is a chip or a portable device with the data license, the transfer of data license can be performed by disconnecting the chip or the portable device from the first electronic device, and connecting the chip or the portable device to the second electronic device.

It is understood that, the electronic device 2100 can have a specific application to perform related operations of digital content management. In some embodiments, the data license generated by the server 1100 can further comprise a specific application code, used to determine whether the specific application is authorized by the server 1100. Before the electronic device 2100 wants to read the content package, the specific application code in the data license can be used to authenticate the specific application in the electronic device. When the authentication is passed, the subsequent procedure of digital content management can be performed.

Therefore, the digital content management methods and systems can generate an independent data license and control license for digital content, and manage the digital content according to the data license and the control license, thus maintaining the user's right of digital content. The digital content management methods and systems further provide convenient manners to transfer digital content among electronic devices. Further, the digital content management methods and systems can record the use and transfer situations of digital content, thus enhancing the management of digital content.

Digital content management methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A digital content management system, comprising:
a storage unit storing at least a digital content; and
a processing unit receiving a device ID of a first electronic device, generating a data license and a control license for the digital content, packing the digital content and the control license as a content package, and respectively transmitting the content package and the data license to the first electronic device, wherein the data license records at least the device ID of the first electronic device, and the control license records at least a read authorization of the digital content.

2. The system of claim 1, wherein the processing unit further receives identity data corresponding to a client, verifies the client according to the identity data, and when the verification of the client is passed, the processing unit generates the data license and the control license, wherein the data license further comprises the identity data.

3. The system of claim 1, wherein the processing unit further generates a journal license corresponding to the digital content, and packs the journal license into the content package, wherein the journal license is used to record a read record of the digital content.

4. The system of claim 1, further comprising a third electronic device for receiving the data license, determining whether a device ID of the third electronic device conforms to the device ID recorded in the data license, and allowing the digital content to be read in the third electronic device according to the read authorization in the control license when the device ID of the third electronic device conforms to the device ID recorded in the data license.

5. The system of claim 2, further comprising a third electronic device for receiving the data license, receiving identity data corresponding to a client, determining whether a device ID of the third electronic device conforms to the device ID recorded in the data license, determining whether the identity data of the client conforms to the identify data recorded in the data license, and allowing the digital content to be read in the third electronic device according to the read authorization in the control license when the device ID of the third electronic device conforms to the device ID recorded in the data license, and the identity data of the client conforms to the identify data recorded in the data license.

6. The system of claim 1, wherein the first electronic device or a second electronic device further obtains a device ID of the second electronic device, generates a new data license for the digital content according to the device ID of the second electronic device, stores the new data license to the second electronic device, and abrogates the data license in the first electronic device, and transmitting the content package from the first electronic device to the second electronic device, wherein the new data license at least records the device ID of the second electronic device.

7. A digital content management system for use in a first electronic device, comprising:
a storage unit storing at least a content package and a data license, wherein the data license records at least a device ID, and the content package at least comprises a digital content and a control license recording at least a read authorization of the digital content; and
a processing unit obtaining the data license, determining whether the device ID of the first electronic device conforms to the device ID recorded in the data license, and allowing the digital content in the content package to be read according to the read authorization in the control license when the device ID of the first electronic device conforms to the device ID recorded in the data license.

8. The system of claim 7, wherein the data license further records identity data, and the processing unit further receives identity data corresponding to a client, determining whether the identity data of the client conforms to the identify data recorded in the data license, and allowing the digital content to be read in the first electronic device according to the read authorization in the control license when the identity data of the client conforms to the identify data recorded in the data license.

9. The system of claim 7, wherein the content package further comprises a journal license corresponding to the digital content, and the processing unit further obtains the control license and the journal license, and determines whether to allow the digital content to be read in the first electronic device according to the control license and the journal license, wherein the journal license is used to record a read record of the digital content.

10. The system of claim 7, wherein the processing unit of the first electronic device or a processing unit of a second electronic device further obtains a device ID of the second electronic device, generates a new data license for the digital content according to the device ID of the second electronic device, stores the new data license to the second electronic device and abrogates the data license in the first electronic device, and transmits the content package from the first electronic device to the second electronic device, wherein the new data license at least records the device ID of the second electronic device.

11. A computer-implemented digital content management method for use in a computer, wherein the computer is programmed to perform the steps of:
receiving a device ID of a first electronic device;
generating a data license and a control license for a digital content, wherein the data license records at least the device ID of the first electronic device, and the control license records at least a read authorization of the digital content;
packing the digital content and the control license as a content package; and
respectively transmitting the content package and the data license to the first electronic device.

12. The method of claim 11, further comprising:
receiving identity data corresponding to a client;
verifying the client according to the identity data; and
generating the data license and the control license when the verification of the client is passed,
wherein the data license further comprises the identity data.

13. The method of claim 11, further comprising:
generating a journal license corresponding to the digital content, wherein the journal license is used to record a read record of the digital content; and
packing the journal license into the content package.

14. The method of claim 11, further comprising:
obtaining the data license by a third electronic device;
determining whether a device ID of the third electronic device conforms to the device ID recorded in the data license; and
allowing the digital content to be read in the third electronic device according to the read authorization in the control license when the device ID of the third electronic device conforms to the device ID recorded in the data license.

15. The method of claim 12, further comprising:
obtaining the data license by a third electronic device;
receiving identity data corresponding to a client;
determining whether a device ID of the third electronic device conforms to the device ID recorded in the data license;
determining whether the identity data of the client conforms to the identify data recorded in the data license; and
allowing the digital content to be read in the third electronic device according to the read authorization in the control license when the device ID of the third electronic device conforms to the device ID recorded in the data license, and the identity data of the client conforms to the identify data recorded in the data license.

16. The method of claim 11, further comprising:
obtaining a device ID of the second electronic device;
generating a new data license for the digital content according to the device ID of the second electronic device;
storing the new data license to the second electronic device, and abrogating the data license in the first electronic device, wherein the new data license at least records the device ID of the second electronic device; and
transmitting the content package from the first electronic device to the second electronic device.

17. A digital content management method for use in a first electronic device, comprising:
providing at least a content package and a data license, wherein the data license records at least a device ID, and the content package at least comprises a digital content and a control license recording at least a read authorization of the digital content;
determining whether the device ID of the first electronic device conforms to the device ID recorded in the data license; and
allowing the digital content in the content package to be read according to the read authorization in the control license when the device ID of the first electronic device conforms to the device ID recorded in the data license.

18. The method of claim 17, wherein the data license further records identity data, and the method further comprises:
receiving identity data corresponding to a client;
determining whether the identity data of the client conforms to the identify data recorded in the data license; and
allowing the digital content to be read in the first electronic device according to the read authorization in the control license when the identity data of the client conforms to the identify data recorded in the data license.

19. The method of claim 17, wherein the content package further comprises a journal license corresponding to the digital content, wherein the journal license is used to record a read record of the digital content, and the method further comprises:
obtaining the control license and the journal license; and
determining whether to allow the digital content to be read in the first electronic device according to the control license and the journal license.

20. The method of claim 17, further comprising:
obtaining a device ID of the second electronic device;
generating a new data license for the digital content according to the device ID of the second electronic device, wherein the new data license at least records the device ID of the second electronic device;
storing the new data license to the second electronic device, and abrogating the data license in the first electronic device; and
transmitting the content package from the first electronic device to the second electronic device.
